(19) United States
(12) Patent Application Publication
(10) Pub. No.: US 2026/0336721 A1
(43) Pub. Date: Oct. 29, 2026

(54) Support for a Motor Vehicle Body, and Method

(71) Applicant: Bayerische Motoren Werke Aktiengesellschaft, Muenchen (DE)

(72) Inventors: Tom CLARKE, Muenchen (DE); Maximilian JUENGLING, Muenchen (DE)

(21) Appl. No.: 19/112,418

(22) PCT Filed: Sep. 27, 2023
(86) PCT No.: PCT/EP2023/076736

§ 371 Date: Mar. 17, 2025

(30) Foreign Application Priority Data
Sep. 30, 2022 (DE) 10 2022 125 386.4

(51) Int. Cl. B62D 27/06; F16B 25/00

(52) U.S. Cl. CPC B62D 27/065; F16B 25/0021

(57) ABSTRACT

A support for a motor vehicle body provides as a cast component and is reinforced at least in a longitudinal region by a rib structure having a number of ribs that are contiguous at least in the region of a rib intersection, and the rib intersection has a receiving opening in which a bolt element for fastening a component to the support is fastened.

### BACKGROUND AND SUMMARY

The invention relates to a support for a motor vehicle body. The invention further relates to a method for producing a support for a motor vehicle body.

Supports for motor vehicle bodies are already sufficiently known from the general prior art. Such a support is, for example, in the form of a cast component and has, for example, a rib structure having a plurality of ribs for reinforcement.

An object of the invention is to provide a support for a motor vehicle body and a method for producing a support for a motor vehicle body so that a weight of the support can be kept particularly low.

This object is achieved according to the invention by a support for a motor vehicle body and by a method for producing a support for a motor vehicle body having the features of the independent claim(s). Advantageous embodiments of the invention are set out in the dependent patent claims and the description.

A first aspect of the invention relates to a support for a motor vehicle body. The term “body” may in particular be understood to be a body for a motor vehicle. The body is preferably in the form of a self-supporting body. The motor vehicle is, for example, in the form of a passenger vehicle, utility vehicle or truck. The support may in particular be referred to as a support element.

The support is in the form of a cast component, in particular a die-cast component. In other words, the support is or can be at least primarily or completely produced by means of casting, in particular by means of die-casting.

The support is reinforced at least in a longitudinal region by means of at least one rib structure which has a plurality of ribs. In other words, at least in the longitudinal region there is arranged the rib structure which has a plurality or a large number of ribs. The support is consequently, in particular at least in the longitudinal region, in the form of a ribbed cast component.

At least in the region of at least one rib intersection, the ribs adjoin each other, in particular directly. In other words, at least two of the ribs intersect each other in the region of the rib intersection or at the rib intersection. Consequently, the rib intersection is formed, in particular at least partially or completely, for example, by the crossing or intersecting ribs. The rib intersection may in particular be referred to as a rib crossing. The term “rib intersection” may in particular be understood to be an intersection region or an interface of the ribs. The rib intersection is preferably part of the rib structure.

In order to be able to keep a weight of the support, in particular of the motor vehicle body, particularly low, there is provision according to the invention for the rib intersection to have a receiving opening in which a bolt element for securing at least one component which is in particular configured separately from the support is or can be secured to the support, in particular at least indirectly or directly. In other words, the bolt element is or can be arranged in the receiving opening for securing the component to the support. This means that the bolt element is or can be secured in the receiving opening in order to secure the component to the support, in particular via the bolt element or the receiving opening. Consequently, a connection of the component to the support can be enabled via the bolt element.

The bolt element may in particular be understood to be a securing element which is preferably in the form of a bolt or of bolt-like form. The bolt element is preferably formed separately from the support. The component is preferably a component of the motor vehicle, in particular the motor vehicle body. Consequently, the component may be understood to be in particular a structural element or a component of the motor vehicle, in particular the body. For example, the component is in the form of an attachment, in particular a trim or trim component.

The invention is based in particular on the following recognitions and considerations. In principle, it is contemplated to close the support or the cast component which may have an open profile with a closure sheet which is, for example, made of steel. In this instance, it is in principle contemplated to arrange, in particular weld, the bolt element which is, for example, in the form of a stroke ignition stud, on or to the closure sheet. This may have a negative effect on the weight of the support or the motor vehicle body since the closure sheet can particularly increase the weight of the support or the motor vehicle body.

In contrast, in the support according to the invention the bolt element is arranged in the receiving opening and consequently on or in the rib intersection. It is thereby possible to dispense with the closure sheet, whereby the weight of the support, in particular of the motor vehicle body, can be kept particularly low. This means that in the cast component, in particular the die-cast component, a complete or particularly high potential weight, for example, of die-cast aluminum can be exploited. On the whole, it can be seen that in the support according to the invention in place of welding the bolt element onto a surface of the closure element, the bolt element can be connected to the support in the receiving opening and consequently via the rib intersection or the rib structure, that is to say, without a closure sheet. The component can thereby be connected to the support, in particular directly, without the closure sheet.

For example, in the region of the rib intersection a material accumulation which is preferably configured to be particularly small or particularly thin may be provided. For example, the receiving opening is at least partially arranged in the region of the material accumulation or at least partially formed by the material accumulation. The material accumulation may be configured to be just as small or just as thin as if the rib intersection were free from the receiving opening, that is to say, would not have the receiving opening. The weight of the support can thereby be kept particularly low. Alternatively, the material accumulation may be configured to be stronger or thicker only to a particularly small extent than if the rib intersection were free from the receiving opening. The weight of the support can thereby be kept particularly low.

Preferably the support or the cast component at least in the longitudinal region has an open cross section. This means that the cross section of the support at least in the longitudinal region is not closed. In other words, the support at least in the longitudinal region is configured to be open at least at one side.

In another embodiment, there is provision for at least one outer wall of the support in the longitudinal region to at least partially, in particular directly delimit a receiving space. In other words, the receiving space is at least partially, in particular directly, covered or surrounded by the outer wall. Preferably, the rib structure is, in particular at least partially, primarily or completely, arranged inside the outer wall. In other words, the rib structure is located at least partially inside the support, in particular inside the cross section. This means that the rib structure, in particular at least partially, primarily or completely, extends inside the open cross section. A rigidity of the support, in particular of the motor vehicle body, can thereby particularly be increased. In particular, in this instance the weight of the support can be kept particularly low. For example, the rib structure extends at least between two, in particular opposing wall regions of the open cross section.

A longitudinal axis of the receiving opening extends preferably perpendicularly to the open side of the support or the longitudinal region. In other words, the extraction direction of the rib structure extends, for example, at least substantially perpendicularly to the open side of the cast component.

In another embodiment, there is provision for the outer wall of the support in the longitudinal region to be configured at least substantially, in particular primarily or completely, in a U-shaped or L-shaped manner. In other words, the support has at least in the longitudinal region an at least primarily U-shaped or L-shaped cross section. This means that the outer wall or the open cross section is in the form of a U-shaped profile or L-shaped profile. The fact that the outer wall of the support in the longitudinal region is configured to be at least substantially U-shaped is intended in particular to be understood to mean that the receiving member of the support in the longitudinal region is configured at least substantially as a box profile or in a box-like manner. The weight of the support, in particular of the motor vehicle body, can thereby be kept particularly low. Furthermore, the support can be produced in a particularly non-complex manner, in particular by means of casting.

Preferably, there is provision for the rib structure to extend within the U-shaped profile or the U-shaped cross section. A rigidity of the support, in particular of the car body, can thereby particularly be increased. In particular, the weight of the support can be kept particularly low in this instance.

In another embodiment, there is provision for the bolt element to be in particular directly secured or to be able to be secured or to become secured in the receiving opening by means of a thread, in particular a self-tapping thread. In other words, the bolt element is in particular directly connected to the support by means of a screw connection. This means that the bolt element, in particular via the thread, is or can be screwed into the receiving opening. Consequently, the bolt element is preferably in the form of a threaded bolt. The bolt element can thereby be secured to the support in a particularly secure and/or particularly non-complex manner.

The fact that the bolt element is or can be secured in the receiving opening by means of the self-tapping thread is in particular intended to be understood to mean that the thread of the bolt element is in the form of a self-tapping thread. A self-tapping thread may in particular be understood to be a cutting thread. This means that the self-tapping thread is configured, when the bolt element is screwed or turned into the receiving opening, to cut a thread which in particular is configured to correspond to the thread of the bolt element in the receiving opening, or in a wall, which at least partially delimits the receiving opening, of the cast component. Consequently, the receiving opening or the cast component is, for example, prior to the turning or screwing of the bolt element, free from the thread, wherein the receiving opening has the thread after the screwing or turning in of the bolt element. In particular, a screw connection may be formed in which the thread of the bolt element is screwed into the thread of the receiving opening or the wall which delimits the receiving opening. In other words, the bolt element can be screwed or screwed into the receiving opening so as to form a thread itself. The support or the motor vehicle body can thereby be produced in a particularly non-complex manner, in particular as a result of the fact that a separate production, in particular cutting, of the thread in the receiving opening can be dispensed with.

Preferably, there is provision for the bolt element to have, at a side facing away from the receiving opening, a thread which is in particular different from the thread of the bolt element and in particular referred to as a second thread and via which the component can be or is secured, in particular becomes secured, for example, directly, to the support, in particular to the threaded bolt. In other words, the thread of the bolt element which is in particular referred to as the first thread is arranged at a side facing the receiving opening, and the second thread is arranged at the side facing away from the receiving opening, wherein the component can be or is connected, preferably directly, to the support, in particular the threaded bolt, via the second thread. Consequently, the bolt element is, for example, in the form of a double bolt. The component can thereby be secured to the support via the bolt element in a particularly non-complex manner.

In another embodiment, there is provision for the bolt element to have a drive element which is arranged between the threads, in particular between the thread and the second thread, via which the bolt element can be acted on with a torque, in particular an assembly torque, in order to secure the bolt element to the support, in particular in order to screw the bolt element into the receiving opening. In other words, via the drive element, the torque, in particular assembly torque, can be applied to the bolt element in order to secure the bolt element to the support, in order in particular to screw the bolt element, in particular the thread, into the receiving opening. The torque can thereby be applied in a particularly advantageous manner to the bolt element, whereby the bolt element can be connected to the support in a particularly non-complex manner. For example, the drive element is arranged in an axial direction of the bolt centrally, that is to say, in the center of the bolt. The drive element is, for example, in the form of a hexagon, in particular an external hexagon.

In another embodiment, there is provision for the rib intersection to have a dome in which the receiving opening is in particular at least partially or completely arranged. In other words, the receiving opening extends at least partially, in particular completely, inside the dome which is formed at least partially by the rib intersection. Consequently, the receiving opening is, for example, arranged in the region of a material accumulation in the form of the dome. The receiving opening can thereby be arranged on the support in a particularly space-saving manner, whereby, for example, a structural space of the support can be configured in a particularly advantageous manner. For example, the material accumulation is configured to be particularly small. In particular, for example, the material accumulation is configured to be as large or only to a particularly small degree larger than if the dome were free from the receiving opening. The weight of the support can thereby be kept particularly low.

The dome is preferably in the form of an ejector dome. The ejector dome is preferably configured for engagement for at least one ejector pin of an, in particular automatic, ejector. The ejector is, for example, part of a tool for producing, in particular for casting, the support or the cast component. For example, via the ejector pin which bears in particular directly on the ejector dome, a pressure can be applied to the support which is located in a casting mold for casting the support in order to press the support out of the casting mold. The ejector dome is consequently provided, for example, for ejecting the support from the casting mold. In other words, the ejector dome may be understood to be in particular a counter-bearing of the ejector pin of the ejector. The ejector dome is preferably formed in a cylindrical manner. The ejector pin may be understood in particular to be a counter-bearing which presses on the ejector dome in order to release the support from the casting mold. For example, the ejector dome, in particular the receiving opening, when the support or the cast component is cast, is at least partially formed or shaped by the receiving pin.

On the whole, it can be seen that by means of the ejector dome both a function with regard to the ejection of the support from the casting mold can be performed and a function with regard to securing the bolt element in the receiving opening and consequently with regard to securing the component to the support can be performed. The weight of the support can thereby be kept particularly low.

In another embodiment, there is provision for the receiving opening to be in the form of an in particular unprocessed blind hole of the cast component. In other words, the receiving opening is in the form of a blind hole which is, for example, unprocessed. Via the blind hole, the bolt element can be connected to the support in a particularly non-complex manner. Furthermore, the receiving opening can be produced in a particularly non-complex manner.

The fact that the receiving opening is unprocessed or is in the form of an unprocessed blind hole may be understood to mean in particular that for the blind hole after the cast component is cast no in particular mechanical processing is carried out or is required. The blind hole is consequently an unfinished cast component or an unfinished region of the cast component, in particular unfinished cast component. A production complexity for producing the support or the blind hole can thereby be kept particularly low.

In another embodiment, there is provision for the support to be in the form of a longitudinal support. In other words, a main extent direction of the support, in particular in the installation position of the support, in the motor vehicle extends at least substantially in the longitudinal vehicle direction of the motor vehicle. In particular, as a result of the support, a rigidity of the motor vehicle body can particularly be increased. Alternatively, there is, for example, provision for the support to be in the form of a node, in particular a cast node.

Preferably, there is provision for the support to be provided for a rear end section of the motor vehicle body or of the motor vehicle. This means that the support is configured for the rear end section, in particular for arrangement in the rear end section. In other words, the support, in particular in the completely produced state of the motor vehicle, is arranged in the rear end section or in a rear section of the motor vehicle. Consequently the longitudinal support can be used in the rear section or the rear section can be used. In particular, the rigidity of the rear end section can particularly be increased by the support.

A second aspect of the invention relates to a method for producing a support, in particular according to the first aspect of the invention, for a motor vehicle body. Advantages and advantageous embodiments of the first aspect of the invention are intended to be considered to be advantages and advantageous embodiments of the second aspect of the invention and vice versa.

The support is in the form of a cast component and is configured at least in a longitudinal region by means of at least one rib structure, which has a plurality of ribs which at least in the region of at least one rib intersection abut each other, in particular directly.

In order to be able to keep the weight of the support particularly low, there is provision according to the invention for the rib intersection to have a receiving opening in which a bolt element for securing at least one component to the support is secured.

Other features of the invention will be appreciated from the claims, the Figures and the description of the Figures. The features and feature combinations mentioned above in the description and the features and feature combinations mentioned below in the description of the Figures and/or shown simply in the Figures can be used not only in the combination set out in each case, but also in other combinations or alone.

The invention will now be explained in greater detail with reference to a preferred exemplary embodiment and the drawings.

### BRIEF DESCRIPTION OF THE DRAWINGS

FIG. 1 is a schematic partial view of a motor vehicle body which has a support according to an embodiment of the invention;

FIG. 2 is a schematic and perspective partial view of a support according to an embodiment of the invention;

FIG. 3 is a schematic side view of a bolt element for securing a component to a support according to an embodiment of the invention;

FIG. 4 is a schematic front view of the bolt element from FIG. 3;

FIG. 5 is a schematic and perspective partial view of an arrangement of a bolt element on a support according to an embodiment of the invention;

FIG. 6 is a schematic partially sectioned view of the bolt element from FIG. 3; and

FIG. 7 is a schematic detailed view of the bolt element from FIG. 6.

In the Figures, elements which are identical or functionally identical are given the same reference numerals.

### DETAILED DESCRIPTION OF THE DRAWINGS

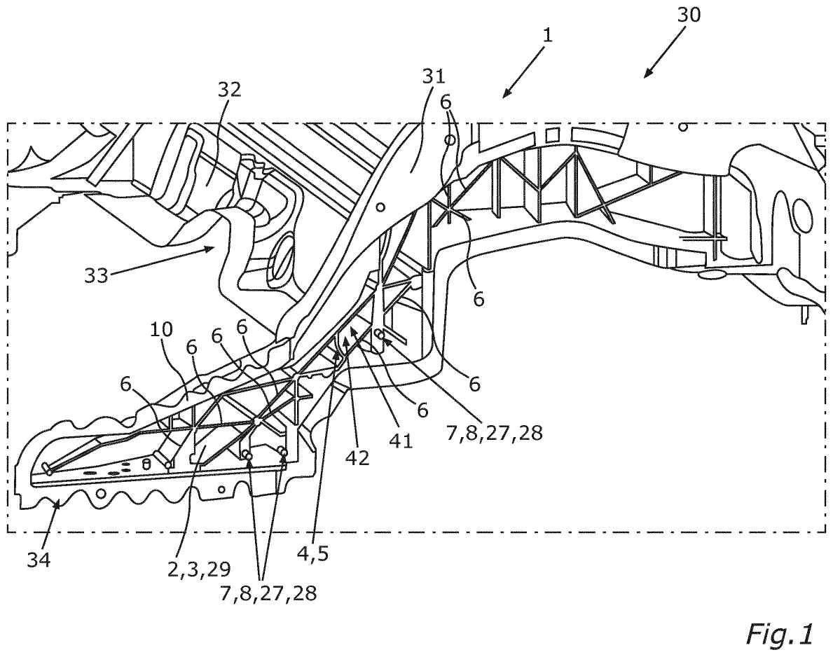

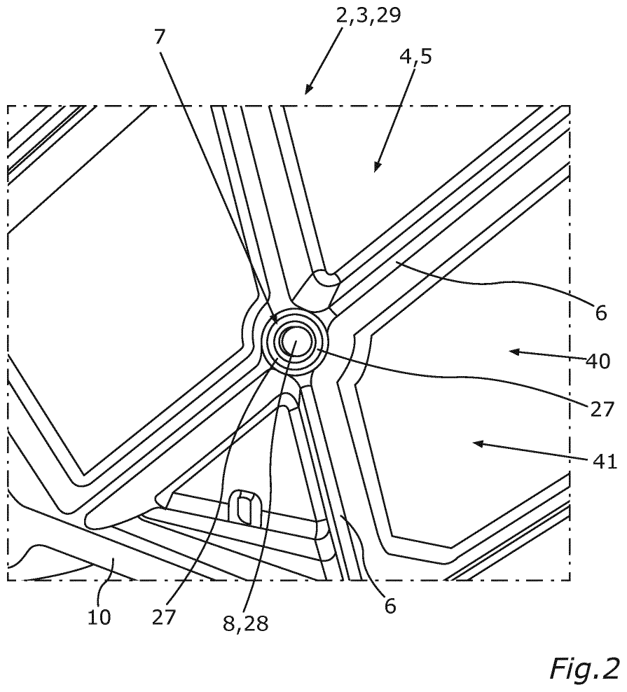

FIG. 1 shows as a schematic and perspective partial view a motor vehicle body 1. The motor vehicle body 1 has at least one support 2 which is in the form of a cast component 3, in particular a die-cast component. FIG. 2 shows the support 2 as a schematic, perspective partial view.

The support 2 is preferably at least partially, in particular primarily or completely, formed from aluminum. Consequently, the cast component 3 is, for example, in the form of an aluminum cast component, in particular an aluminum die-cast component.

The support 2 or the cast component 3 is reinforced at least in a longitudinal region 4 by at least one rib structure 5 which has a plurality of ribs 6. The ribs 6 adjoin each other in particular directly at least in the region of at least one rib intersection 7.

In the exemplary embodiment shown in FIG. 1, the rib structure 5 has a plurality of rib intersections 7. At the respective rib intersection 7, at least two of the ribs 6 adjoin each other, in particular directly. The ribs 6 which adjoin each other, in particular cross or intersect, at the respective rib intersection 7 extend, for example, obliquely or perpendicularly to each other.

In order to be able to keep the weight of the support 2 particularly low, there is provision for the respective rib intersection 7 to have at least one respective receiving opening 8 in which a respective bolt element 9 for securing at least one component which is configured in particular separately from the support 2 is or can be secured to the support 2. In other words, the respective bolt element 9 is or can be connected via the respective receiving opening 8 to the support 2, in particular directly. This means that the component is or can be connected, in particular directly, to the support 2 via the respective bolt element 9. Consequently, the respective bolt element 9 can be introduced into the respective rib intersection 7 in each case.

In another embodiment, there is provision for the support 2 at least in the longitudinal region 4 to have an open cross section 41, wherein an outer wall 10 of the support 2 partially delimits a receiving space 42 in the longitudinal region 4. In other words, the support 2, in particular the outer wall 10, at least at one side, has no continuous surface. Preferably, the rib structure 5 is arranged within the outer wall 10. For example, there is provision for at least the outer wall 10 of the support 2 to be configured in an at least substantially U-shaped manner in the longitudinal region 4, wherein the rib structure 5 is arranged within the outer wall 10. Consequently, the support 2 is preferably an open, in particular ribbed, cast component 3.

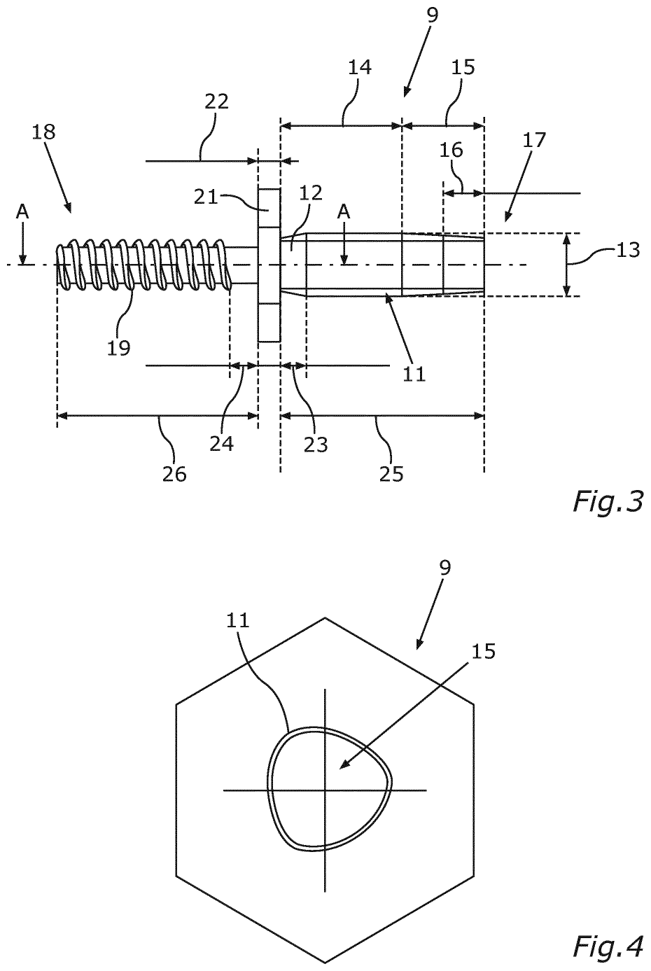

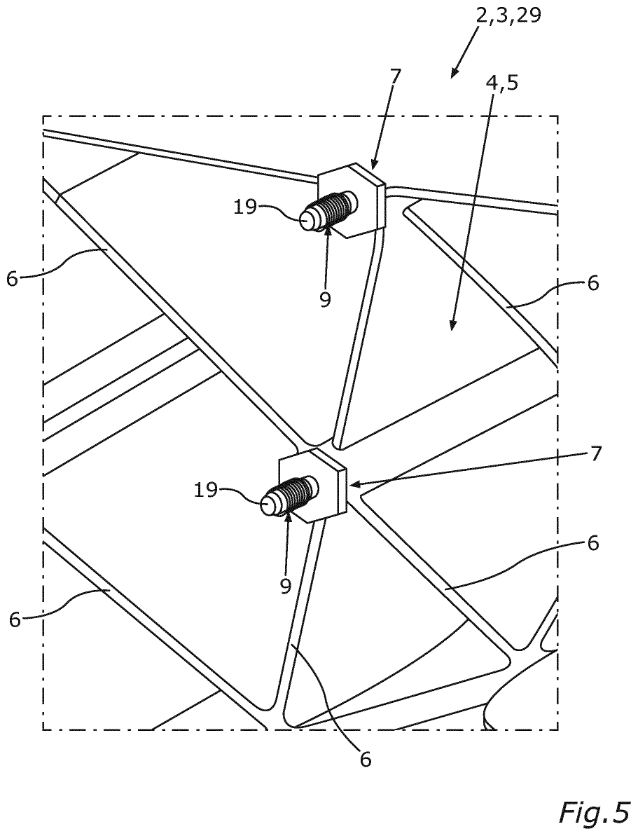

FIG. 3 shows as a schematic side view the respective bolt element 9. FIG. 4 shows the respective bolt element 9 as a schematic front view. FIG. 5 shows an arrangement of the respective bolt element 9 on the support 2 as a schematic and perspective partial view. Consequently, FIG. 5 shows bolt elements 9 mounted on the support 2.

Preferably, there is provision for the respective bolt element 9 to be secured or to become secured in the receiving opening 8 by means of a respective thread 11, in particular a respective self-tapping thread 11. For example, the respective bolt element 9 has a respective base member 12 on which the thread 11 is arranged. The thread 11 is preferably in the form of an outer thread. For example, by means of the respective self-tapping thread 11, a respective inner thread for securing the respective bolt element 9 via the thread 11 thereof can be introduced, in particular cut, in the respective receiving opening 8.

A diameter 13 of the thread 11 corresponds, for example, to an M6, in particular M6GF thread. For example, the thread 11 has a first region 14 and a second region 15 which is, at least indirectly, in particular directly, adjacent to the first region 14. The first region 14 is, for example, configured in a cylindrical manner. The second region 15 is, for example, provided for thread cutting. For example, the second region 15 is configured in a trilobular manner. The first region 14 has, for example, a length of 12 mm. The second region 15 has, for example, a length of 12 mm, the second region 15 has, for example, a length of 8 mm. For example, the thread 11, in particular the second region 15, has at least one, in particular a maximum of four, one-groove threads 16.

For example, the respective bolt element 9 has a first side 17 and a second side 18 which is different from the first side 17. The sides 17, 18 are preferably opposite each other, in particular in an axial direction of the respective bolt element 9. Preferably, the thread 11 is arranged at the first side 17. Consequently, the first side 17 is preferably a side 17 facing the receiving opening 8. The first side 17 may in particular be referred to as the cast side.

The second side 18 is preferably a side 18 facing away from the receiving opening 8 or the support 2. For example, the respective bolt element 9 has at the second side 18 a second thread 19 which is different from the thread 11 in particular referred to as the first thread 11 and via which the component can be or is secured, in particular directly, to the support 2. The second thread 19 is, for example, in the form of an outer thread. The second side 18 may in particular be referred to as the side for use. Consequently, the component can be secured to the side for use.

In another embodiment, there is provision for the respective bolt element 9 to have a respective drive element 21 which is arranged between the first thread 11 and the second thread 19 and via which the respective bolt element 9 can be acted on with a torque in order to secure the respective bolt element 9 to the support 2. In other words, the respective bolt element can be caused to rotate via the drive element thereof in order to screw the respective bolt element 9 via the first thread 11 to the support 2, in particular in the receiving opening 8. Consequently, the drive element 21 is provided for assembly of the bolt element 9. The drive element 21 is, for example, in the form of a hexagon which has, for example, a size across flats of 13. For example, the drive element 21 is arranged, in particular directly, on the base member 12, in particular between the threads 11, 19.

For example, a thickness 22, which extends in the axial direction of the respective bolt element, of the respective drive element 21 of the respective bolt element 9 corresponds to 2.25 mm, in particular 2.25 mm±0.25 mm. For example, the respective thread 11 in the axial direction of the respective bolt element 9 is spaced apart from the respective drive element 21 with a spacing 23. The spacing 23 corresponds, for example, to a maximum of 2.5 mm. For example, the respective second thread 19 is spaced apart in the axial direction of the respective bolt element 9 from the respective drive element 21 with a second spacing 24. For example, the second spacing 24 corresponds to a maximum of 2.5 mm. For example, a length 25, which extends from the respective drive element 21 in the axial direction of the respective bolt element 9 in the direction of the support 2, of the respective bolt element 9 corresponds to 20 mm, in particular 20 mm±0.42 mm. For example, a second length 26 which extends from the respective drive element 21 in the axial direction of the respective bolt element 9 in the direction away from the support 2 corresponds to 20 mm, in particular 20 mm±0.5 mm.

For example, the respective bolt element 9 is configured in an integral manner. This means that the respective bolt element 9 is formed from one piece, for example, a monobloc. For example, the first thread 11 and/or the second thread 19 and/or the drive element 21 and/or the base member 12 are configured together in one piece, that is to say, integrally with each other.

In another embodiment, there is provision for the respective rib intersection 7 to have in each case a respective dome 27 in which the respective receiving opening 8 is in particular at least partially arranged. The respective dome 27 is preferably in the form of an ejector dome. This means that, in particular as a result of the material accumulations, the respective ejector dome becomes or is introduced in the respective rib intersection 7. As a result, the respective receiving opening 8 or the respective bolt element 9 may be provided, in particular in a particularly non-complex manner, in the respective rib intersection 7.

Preferably, there is provision for the respective receiving opening 8 to be in the form of an in particular unprocessed blind hole 28 of the cast component 3 or of the support 2. This means that, in particular in order to be particularly suitable for the use for securing the component, the respective ejector dome can be adapted or modified by the blind hole 28 being pre-cast in this instance. In this instance, there is preferably provision for the function as an ejector dome to be maintained.

Preferably, there is provision for the support 2 to be in the form of a longitudinal support 29. Preferably, there is provision for the support 2, in particular the longitudinal support 29, to be provided for a rear end section 30 of the motor vehicle body 1. In other words, the support 2 or the longitudinal support 29 is in the form of a rear longitudinal support 29 of the motor vehicle body 1.

For example, the motor vehicle body 1, in particular the rear end section 30, has a wheel house carcass, in particular a wheel house carcass component 31. The support 2 is arranged, for example, at the inner side on the wheel house carcass component 31, in particular directly. For example, the component is in the form of a wheel house trim or a wheel house shell, in particular, wheel house inner shell. For example, the support 2 is part of the wheel house carcass. Alternatively, the support 2 may be configured separately from the wheel house carcass. For example, the support 2 is connected, in particular directly, to the wheel house carcass 31.

For example, the component is in the form of an adapter plate. For example, the component is in the form of a line element, in particular a cable harness, an electric line, a line for data transmission, a brake line, a cooling line and/or an air line. For example, the line element is connected to the bolt element 9 by means of at least one clip, in particular a plastics material clip, which is connected, in particular screwed, to the bolt element 9 by means of at least one, in particular by means of the second thread 19.

For example, at least one cross beam adjoins the support 2, for example, at least immediately or directly, in particular inwardly in the transverse vehicle direction. For example, the motor vehicle body 1 has at least one additional support which is spaced apart from the support 2 in particular in the transverse vehicle direction. For example, the support 2 and the additional support are connected to each other, for example, at least indirectly or directly by means of the at least one cross beam. For example, the support 2 and in particular the at least one cross beam, forms a connection with at least one base element and/or at least one luggage space base. The base element is, for example, in the form of a base plate, in particular a main base, or a base beam.

For example, the motor car body 1, in particular the rear end section 30, has a rear wall 32 which, for example has a central tunnel-like member 33. Alternatively, the rear wall is, for example, free from the central tunnel-like member 33.

For example, the wheel house carcass, in particular the wheel house carcass component 31, and/or the support 2, is arranged in particular at least indirectly or directly, for example, at the outer side on the rear wall 32. For example, the support 2 has at least one connection region 34 for securing a door sill and/or a side wall. The door sill or the side wall is, for example, part of the motor car body 1.

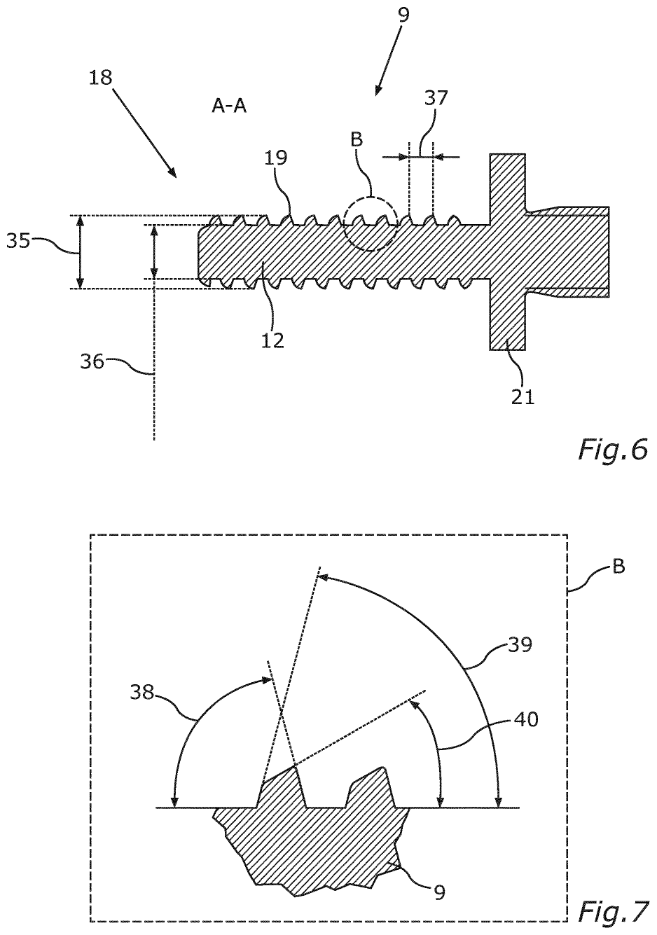

FIG. 6 shows the respective bolt element 9 as a schematic partially sectioned view, wherein FIG. 6 shows a section A-A which extends between section reference points A which are indicated in FIG. 3. For example, the second thread 19 has a thread diameter 35 of 5 mm, in particular 5 mm±0.1 mm. For example, the base member 12 has in the region of the second thread 19 a base member diameter 36 of, for example, 3.6 mm, in particular 3.6 mm±0.15 mm. For example, a pitch 37 of the second thread 19 corresponds to 1.6 mm.

FIG. 7 shows a detailed view B of the section A-A shown in FIG. 6. A first angle 38 shown in FIG. 7 is, for example, 75 degrees. A second angle 39 shown in FIG. 7 corresponds to, for example, 75 degrees. A third angle 40 shown in FIG. 7 corresponds to, for example, 30 degrees.

### LIST OF REFERENCE NUMERALS

1 Motor vehicle body
2 Support
3 Cast component
4 Longitudinal region
5 Rib structure
6 Ribs
7 Rib intersection
8 Receiving opening
9 Bolt element
10 Outer wall
11 First thread
12 Base member
13 Diameter
14 First region
15 Second region
16 One-groove thread
17 First side
18 Second side
19 Second thread
21 Drive element
22 Thickness
23 Spacing
24 Second spacing
25 Length
26 Second length
27 Dome
28 Blind hole
29 Longitudinal support
30 Rear end section
31 Wheel house carcass component
32 Rear wall
33 Central tunnel-like member
34 Connection region
35 Thread diameter
36 Base member diameter
37 Pitch
38 First angle
39 Second angle
40 Third angle
41 Cross section
42 Receiving space
A Section reference point
A-A Section
B Detailed view

1.-7. (canceled)

8. An arrangement of a bolt element on a support for a motor vehicle body, comprising:
a cast support component of the motor vehicle body, wherein at least in a longitudinal region, the cast component is reinforced by a rib structure having a plurality of ribs which adjoin each other at least in a region of a rib intersection,
wherein the rib intersection has a receiving opening in which the bolt element is secured to the support in order to secure a component, and
wherein at least one of:
(i) the bolt element is secured in the receiving opening via a self-tapping thread,
(ii) the bolt element has, at a side facing away from the receiving opening, a thread via which the component is securable to the support, or
(iii) the bolt element has a drive element which is arranged between the threads and via which the bolt element is acted on with a torque in order to secure the bolt element to the support.

9. The arrangement according to claim 8, wherein
the support, at least in the longitudinal region, has an open cross section, and
an outer wall of the support in the longitudinal region partially delimits a receiving space in which the rib structure is arranged within the outer wall.

10. The arrangement according to claim 9, wherein
the rib intersection has a dome in which the receiving opening is arranged.

11. The arrangement according to claim 8, wherein
the receiving opening is in the form of a blind hole of the cast support component.

12. The arrangement according to claim 8, wherein
the support is in the form of a longitudinal support.

13. The arrangement according to claim 8, wherein
the support is a rear end section support of the motor vehicle body.

14. A method for producing a support for a motor vehicle body, the method comprising:
casting the support as a cast component reinforced at least in a longitudinal region by a rib structure having a plurality of ribs which adjoin each other at least in the region of a rib intersection, wherein the rib intersection has a receiving opening in which a bolt element is secured in order to secure a component to the support, and
wherein at least one of:
(i) the bolt element is secured in the receiving opening via a self-tapping thread,
(ii) the bolt element has, at a side facing away from the receiving opening, a thread via which the component is secured to the support, or
(iii) the bolt element has a drive element which is arranged between the threads and via which the bolt element is acted on with a torque in order to secure the bolt element to the support.
